(19) United States
(12) Patent Application Publication
(10) Pub. No.: US 2026/0239351 A1
(43) Pub. Date: Aug. 13, 2026

(54) ARTIFICIAL INTELLIGENCE (AI) BASED UPLINK CONTROL INFORMATION (UCI) REPORT

(71) Applicant: Apple Inc., Cupertino, CA (US)

(72) Inventors: Huaning Niu, San Jose, CA (US); Oghenekome Oteri, San Diego, CA (US); Haitong Sun, Cupertino, CA (US); Dawei Zhang, Saratoga, CA (US); Wei Zeng, Saratoga, CA (US); Weidong Yang, San Diego, CA (US)

(21) Appl. No.: 19/152,567

(22) PCT Filed: Jan. 16, 2024
(86) PCT No.: PCT/US24/11624

§ 371 Date: Jul. 31, 2025

Related U.S. Application Data
(60) Provisional application No. 63/485,450, filed on Feb. 16, 2023.

(51) Int. Cl. H04W 72/21; H04L 41/16

(52) U.S. Cl. CPC H04W 72/21; H04L 41/16

(57) ABSTRACT

A user equipment (UE), a base station, a baseband processor or other network device can operate in a network to process a network configuration of an uplink control information (UCI) payload of an artificial intelligence (AI) based channel state information (CSI) feedback. The network configuration includes indications of a UCI configuration and an AI model in order to generate an AI based UCI report. The AI model is associated with at least one of: a layer common configuration, a layer specific configuration, or a rank indication (RI) specific configuration according to the network configuration.

### REFERENCE TO RELATED APPLICATIONS

This Application claims the benefit of U.S. Provisional Application No. 63/485,450, filed on Feb. 16, 2023, the contents of which are hereby incorporated by reference in their entirety

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) and network devices, such as base stations, to communicate with one another. Massive multiple-input and multiple-output (MIMO), which equips the base station (BS) with many antennas, can considerably improve system performance. However, the benefit of massive MIMO is based on the knowledge of channel state information (CSI) feedback. In frequency division duplexing (FDD) massive MIMO systems, the UE operates to feedback downlink CSI to the BS through the uplink because of a lack of channel reciprocity. The feedback overhead can be substantial due to the high dimension of CSI in massive MIMO systems.

### BRIEF DESCRIPTION OF THE DRAWINGS

FIG. 1 illustrates an example of a signaling diagram for configuration of a UCI report in accordance with various aspects.

FIG. 2 illustrates a structure of the auto-encoder/decoder-based CSI feedback.

FIG. 3 illustrates an example of AI configurations/methods for AI UCI based reports in accordance with various aspects.

FIG. 4 illustrates AI model data defined in accordance with various aspects.

FIG. 5 illustrates an example of AI configurations/methods for AI UCI based reports in accordance with various aspects.

FIG. 6 illustrates an example of AI configurations/methods for AI UCI based reports in accordance with various aspects.

FIG. 7 illustrates an example of AI configurations/methods for AI UCI based reports in accordance with various aspects.

FIG. 8 illustrates an example of a CSI feedback in AI based UCI reporting in accordance with various aspects.

FIG. 9 illustrates an example of an AI model ID list in accordance with various aspects.

FIG. 10 illustrates an exemplary block diagram illustrating an example of user equipment(s) (UEs) communicatively coupled a network with network components as peer devices useable in connection with various embodiments (aspects) described herein.

FIG. 11 illustrates an example simplified block diagram of a user equipment (UE) wireless communication device or other network device/component (e.g., eNB, gNB) in accordance with various aspects.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects include methods and configurations of artificial intelligence (AI) based uplink (UL) control information (UCI) for UCI reporting of channel state information (CSI) feedback. AI models can automatically compress and reconstruct CSI in order to considerably improve feedback accuracy compared with codebook and compressive sensing (CS) based feedback algorithms. AI provides a machine or system with ability to dynamically simulate human intelligence and behavior. Unlike conventional methods that are supported by domain knowledge and theoretical proofs, AI based CSI methods, including deep learning and reinforcement training, can automatically learn or extract features from a training dataset. To efficiently learn the features from the dataset, neural network (NN) architectures, such as dense, convolutional, and recurrent NNs, are being developed and introduced into wireless communications, especially with integrating AI into the air interface. AI and machine learning (ML) can be used interchangeably, where ML may be referred to as a sub-domain of AI research. A typical implementation of AI/ML is with a NN, such as a conventional neural network (CNN), a recurrent/recursive neural network (RNN), a generative adversarial network (GAN), or the like. The following description may take the neural network as an example of an AI/ML model; however, it is understood that the AI/ML model discussed here may not necessarily be limited thereto, and any other model that performs inference on the UE or the network side of a network is possible.

In an aspect, a UE can operate to receive a network configuration that is for a UCI payload of an AI based CSI feedback, as provided by the base station. The network configuration can include indications of a UCI configuration and an AI model. These indications provided by the network configuration can be used to generate an AI based UCI report of the AI based CSI feedback. Specifically, the network configuration indicates to the UE how to report UCI bits by the UCI configuration and the AI model. The UCI configuration indicates a number of UCI bits and the AI model indicates how to perform encoding of the UCI bits by an encoder for signaling to the network or base station. The UCI bits of an AI based UCI report are then decoded by a decoder component at the base station. The AI based UCI report is generated by the UE based on the network configuration, and then provided to the base station to allow for efficient handling of CSI for wireless transmissions. The network configuration can further indicate an AI method or configuration to utilize for UCI encoding of AI based CSI feedback compression in an AI based UCI report. For example, the AI method or AI configuration for the AI based UCI report can include a layer specific configuration, a layer common configuration, or a rank specific configuration.

In another aspect, a network device or a base station can provide a network configuration of a UCI payload to the UE. The network configuration indicates a UCI configuration and an AI model. The network configuration can comprise an AI model ID that indicates the UCI configuration and the AI model, for example. An AI based UCI report of AI based CSI feedback can then be received by the network according to the provided network configuration.

The AI models being utilized for AI based CSI feedback compression in AI based UCI reporting herein can be configured as two sided AI models for AI based wireless communication. The two sided models may considerably improve feedback accuracy compared with codebook and compressive sensing based feedback algorithms, and further serve to potentially replace the legacy e-Type II codebook based coding and decoding with a neural network (NN) based encoder and decoder, respectively. Consequently, the existing CSI feedback standard may face a large overhaul, while the need for UCI encoding rules for AI based CSI feedback compression remains along with a structure and priority for UCI omission rules for managing the UCI payload bit size.

Additional aspects and details of the disclosure are further described below with reference to figures.

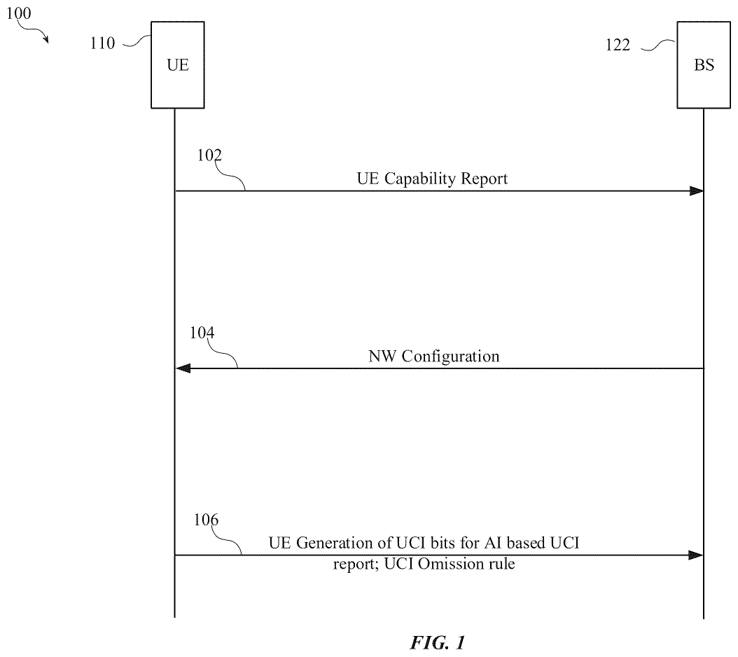

FIG. 1 illustrates an example signal flow 100 between a UE 110 and a network device or base station 122 (e.g., a gNB, or other network component) for configuring an AI based UCI report for CSI feedback or AI based CSI feedback in order to enable efficient wireless communications between antennas. The UE 110 can include a smartphone (e.g., handheld touchscreen mobile computing devices connectable to one or more wireless communication networks). Additionally, or alternatively, UE 110 can include other types of mobile or non-mobile computing devices configured for wireless communications, such as personal data assistants (PDAs), pagers, laptop computers, desktop computers, wireless handsets, etc. UE 110 can include one or more UEs 110 such as internet of things (IoT) devices (or IoT UEs). Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, or the like. Additionally, the UE 110 can include vehicle UEs, pedestrian UEs, or vehicle to everything (V2X) UEs.

A UE can perform an estimation of the channel for CSI feedback after precoding (or beamforming). Codebooks for CSI are generally supported for CSI beam selection, co-phasing between polarizations, and beam combining operations. CSI can include channel quality information (CQI), a rank indication (RI) and a precoding matrix indication (PMI). CQI, for example, can provide information about the signal to noise plus interference ratio (SINR) of a transmission channel or layer. Based on the CSI recommended by the UE, the base station applies an appropriate modulation and coding scheme (MCS) to subsequent UE transmissions. A low SINR for one transmission channel may result in a low MCS being used relative to another transmission channel having a higher or better SINR. The base station and UE thereafter communicate using the MCS elected, at least until channel conditions between them change. The other components, including PMI and RI are associated with multiple-input-multiple-output (MIMO) transmissions, in which MIMO generally refers to multiple sets of antennas on either or both of the receiver/transmitter in a wireless cellular system.

Generally, the MIMO feedback framework includes an e-Type II codebook design, in which the UCI encoding and omission rules were specified, for two parts of CSI: CSI part 1 and CSI part 2. CSI part 1 includes the RI, wideband CQI, sub-band CQI, and a total number of non-zero coefficients (K_{NZ, TOT}). CSI part 2 includes three groups of data in terms of priority: Group 1>Group 1>Group 2. The omission rule for omitting UCI bits, when exceeding a specified UCI bit threshold, operates according to the group priority, including a layer>spatial basis>frequency basis. In the MIMO framework, it is possible to transmit multiple beams (also known as spatial spatial layers, MIMO layers, or transmission layers herein) over the same time and frequency resources to maximize spectral efficiency. A transmission layer or MIMO spatial layer herein can refer to codebook layers of a MIMO spatial and/or frequency precoders for transmission. The RI indicates the number of MIMO spatial layers that can be simultaneously transmitted to the UE. Thus, for example, if the UE is located within a line-of-sight to the base station, the base station can simultaneously transmission two signals over the same time and frequency resources by using, for example, two orthogonal polarizations. Because of their orthogonality, the two signals do not create interference with one another even though the same time and frequency resources are used. AI based UCI reporting of CSI feedback (or as AI based CSI feedback compression) promises performance improvement and complexity reduction. AI based CSI feedback, as referred to herein, includes deep learning to automatically compress and reconstruct CSI with a considerable improvement in feedback accuracy. In particular, for AI based UCI reporting, the UCI encoding rule and omission rule remain to be specified, which can be advantageous for utilizing AI based models that are utilized to efficiently and effectively manage massive MIMO feedback. The AI based UCI encoding does not utilize non-zero coefficient processes, and also does not implement clear structures regarding the frequency basis or the spatial basis for adaptive control over beam patterning.

The signaling flow 100 can initiate with the UE 110 providing a UE capability report 102 to the base station 122. The UE capability report 102 can indicate support for one or more AI models, one or more AI model IDs associated with the one or more AI models, or one or more UCI configurations for generating an AI based UCI report of AI based CSI feedback. Before deployment of AI enabled CSI feedback processes and systems, many issues can be resolved by training with datasets for various UEs of particular proprietors and network vendors. The particular AI model for configuring the CSI feedback, and thus, the AI based UCI report is likely going to be left independent design. As such, the design of an AI mode and the specific way it operates will be determined based on the partner of each vendor and from a signaling point of view can be pre-trained AI models prior to deployment, involving trials with an encoder and decoder component pairing. During the deployment, when the UE 110 is processing the CSI feedback with interference processes, depending on which model format is pre-trained, or supported, the corresponding AI model can be communicated at 102 between the UE 110 and network base station 122 to establish which pair link encoder decoder processes to perform. Statistical information related to the dataset generation, the dataset itself, the AI model design, the manner training, the last function and other optimization processes can thus be implementation specific without being specified or known other than a UE capability report.

Before deployment, the UE 110 and base station 122 can perform offline training of a set of paired models for encoder (the UE 110) and decoder (the network) base station 122. Each AI model can be associated with a unique model ID. The UE vendor and NW vendor offline may have agreed on supporting one or more AI model methods/configurations when training. These AI model configurations can be a layer common configuration, a layer specific configuration, a rank specific configuration, or any combination thereof. The UE capability report signaling 102 can include one or more supporting AI model IDs associated with AI models, respectively.

An AI model ID herein can include a UE vendor ID, network device vendor ID, a usage case ID, a sub usage case ID, a model ID for the use case, an input output format, a UCI configuration for a number of UCI bits, an AI model associated with the AI model ID or an AI model index, as well as an AI model configuration. The supported UCI configuration may not support all UCI configurations, but a set of UCI configurations that designate one or more from among a set of UCI configurations (e.g., 60 bits, 80 bits, 90 bits, 120 bits, 240 bits, or other amount of UCI bits). The AI configuration can refer to a layer common configuration, a layer specific configuration, and an RI or rank specific configuration, or any combination thereof. Depending on model ID definition, the AI model ID or the network configuration can represent or indication any one or more of information above associated with the AI model ID. Thus, each variation of a number of UCI bits for the UCI configuration or change of the AI configuration could be associated with a unique model ID. In an aspect, the network could therefore provide only the AI model ID or model ID for providing one or more indications of the UCI configuration, the AI model, the AI configuration, as well as one or more of: a UE vendor ID, a network device vendor ID, a usage case ID, a sub usage case ID, a model ID for the use case, or an input output format.

The base station 122 provides the network configuration signaling 104, which can be based on or derived from the UE capability report, for example. The network configuration can include the AI model ID, a UCI configuration or the AI Model to configure the AI based UCI reporting at the UE 110. The network configuration can be a dynamic configuration based on the network cell or an analysis of the environment of the network with the UE 110. Given that wireless channels depend on the propagation environment, the channel of a certain cell can demonstrate certain characteristics that can be regarded as environmental knowledge. AI in particular can be a tool that aids well in extracting and utilizing environmental knowledge to help CSI feedback via end-to-end learning.

In response to receiving the network configuration associated with AI based UCI reporting, the UE 110 generates the AI based UCI report 106 for CSI feedback in order to facilitate wireless communication with the base station 122. The AI model is utilized to generate UCI bits for the AI based UCI report with the CSI feedback according to an AI configuration/method. The UE 110 can further configure a UCI omission rule if provided a maximum UCI bit payload to omit some bits over others based on a UCI omission rule threshold.

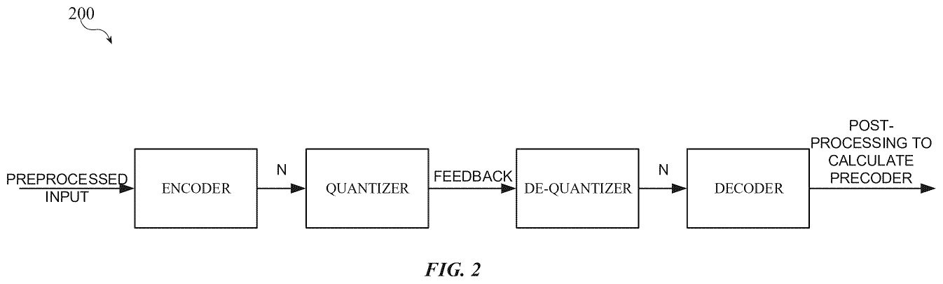

CSI feedback reduction methods can lead to excessive feedback overhead, especially with the implementation of massive MIMO. Auto-encoder/decoder-based CSI feedback enhancement is an example of an approach for addressing this challenge. FIG. 2 illustrates an abstract level structure of the auto-encoder/decoder-based CSI feedback. As illustrated in FIG. 2, on the UE side, preprocessed CSI input is encoded by an encoder component, which can be an AI model. Then the CSI input is quantized by a quantizer, after which it is transmitted to the network. On the network side, the CSI feedback is dequantized by a de-quantizer, and decoded by a decoder, which may also be an AI model, so as to calculate a precoder.

The auto-encoder/decoder-based approach can train the overall encoder and decoder NN by deep learning, so as minimize the overall loss function of the decoder output versus the encoder input. The encoder/decoder training is centralized, while the inference function is split between UE and NG-RAN node (e.g., gNB), that is, encoder inferencing is at the UE 110, and decoder inferencing is at the gNB or base station 122. To achieve this, UE-gNB collaboration with model transfer over the air as discussed before deployment could facilitate prior to the signaling flow 100.

In this example, the NN including both of the encoder and the decoder is a two-sided model. If the NN is trained and owned at the network side, for example, by the network device vendor, a part of the NN (i.e., the auto-encoder for inference at the UE) is downloaded to the UE 110. If the NN is trained and owned at the UE side, for example, by the UE vendor, a part of the NN (i.e., the auto-decoder for inference at the gNB side) is uploaded to the gNB or base station 122. Furthermore, the NN may be trained and owned by a 3rd party, so that two parts of the NN are transferred to the UE 110 and the base station 122, respectively.

Alternatively, the auto-encoder or the auto-decoder may be trained separately as a one-sided model. For example, the UE vendor may train only the encoder NN based on downlink measurement data in different cells, and the network device vendor may train only the decoder NN based on uplink data for different UEs. In this case, the UE 110 and the gNB 122 may acquire respective NNs from a server of the UE vendor or a server of the network device vendor, respectively.

On the one hand, the network may have different deployments, such as indoor, Umi or Uma deployment, different number of antennas deployed in the cell, a single TRP (sTRP) or multiple TRPs (mTRP), and thus a number of NNs may be trained to enable flexible adaptive codebook design to optimize the system performance. On the other hand, the UE 110 may have different individual AI capabilities, or memory limitations, and thus, a number of NNs may be trained with various AI models to adapt to UE differentiation.

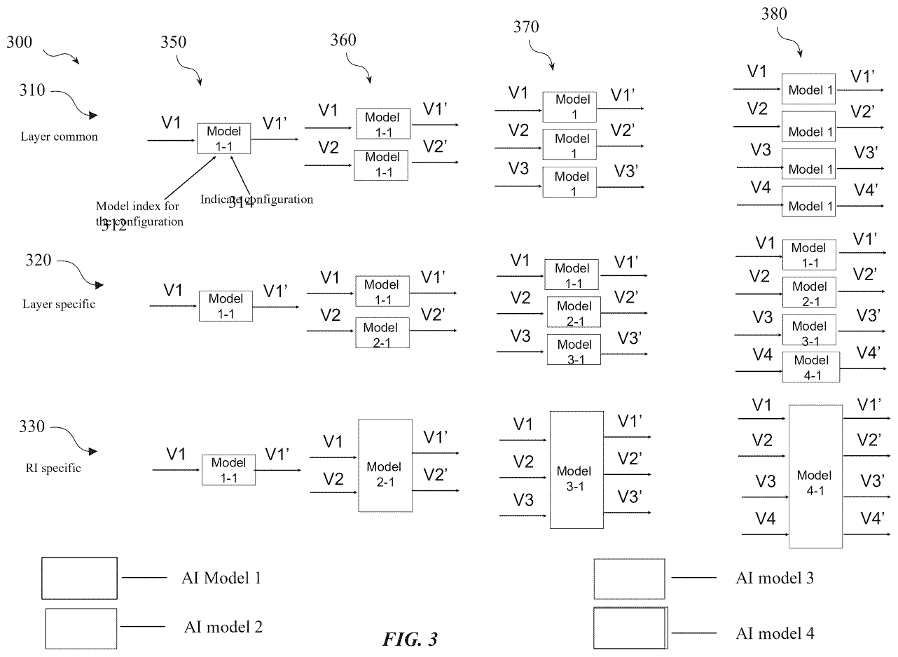

FIG. 3 illustrates an example of various AI configurations 300 for generating AI based UCI reports based on a network configuration. The network configuration indicates one or more of: AI model ID(s), AI model(s) or UCI configuration(s). Various AI models are illustrated based on hash mark differentiation including AI models 1 thru 4, for example, although a fewer or a greater number of AI models can be utilized and configured according to the network configuration by the base station 122. The AI models 1 thru 4 are hash marked differently and illustrated according to a corresponding AI configuration and a corresponding rank. The AI configuration can include a layer common configuration 310, a layer specific configuration 320 or an RI specific configuration 330 illustrated for example from top to bottom and corresponding rank or RI for RI=1 350, RI=2 360, RI=3 370, and RI=4 380.

Each AI model includes an encoder and a decoder as encoder-decoder pairs with one or more inputs as V # (e.g., V1 or the like) providing one or more outputs as V number prime (e.g., V1′). Once obtaining channel through a cell specific reference signal (CS-RS), a sub-band covariance matrix can be determined based on the sub-band size configuration. For example, if a 72 antenna is present at the network, a 72×72 covariance matrix per sub-band can be determined, and then a factor V of the covariance matrix is calculated, which could be represented by the input (e.g., V1, V2, V3, V4, etc.) and an output as V primed (e.g., V1′, V2′, V3′, V4′, etc.). However, this calculation process can be up to specific implementation and any particular AI model could be configured according to AI/ML or deep learning processes, as represented by AI models with varied hash markings. Thus, how the UE 110 performs measurements and calculates the factor V or V′ can be up to various implementations.

Each AI model or AI model ID can include a model index to indicate the particular AI model associated with a UCI configuration and an indicated UCI configuration. For example, an AI model ID of Model 1-1, for example, comprises a first indication 312 that indicates a first AI model (or AI model 1) that is associated with a second indication 314 such as a UCI configuration index of 1 that indicates a particular UCI configuration associated with the AI model. A UCI configuration 314 indicates a number of UCI bits for the UCI payload of the AI based UCI report, or a number of UCI bits for the UE feedback based on the network configuration. For example, a UCI configuration 1 can be 60 bits, a UCI configuration 2 can be 80 or 90 bits, a configuration 3 could indicate 120 bits, for example. These are examples for a UCI configuration indication 314 and the model index indication 312 for that associated UCI configuration 314 indicates, for example, for 60 bits whether the UE performs one AI model, two AI models or multiple AI models according to the model index indication 312 in its AI based UCI reporting.

For reporting AI based UCI reports, the UE 110 can configure a layer common configuration 310 based on the network configuration. A layer common configuration 310 is configured for each UCI payload to correspond to one AI model according to this AI configuration. Thus, each MIMO layer or transmission layer being reported in the AI based UCI report uses the layer common configuration 310 for the AI configuration for each RI 350 thru 380. The layer common configuration 310 indicates that a same AI model is to be used across any number of transmission layers for any given RI 350-380. For example, where RI=1 at RI 350, a transmission layer uses an AI model 1, which is associated with the particular AI model being used for generation of the UCI bits to report this transmission layer in the AI based UCI report. Where RI=2, at RI 360, the transmission layers both use a same AI model 1. Where R=3 at RI 370 all three transmission layers use the same AI model 1. Likewise, where R=4 at RI=380 all four transmission layers use the same AI model (AI model 1).

When generating an AI based UCI reporting with the layer common configuration 310, where the feedback RI=1 at 350, an output of a V1 factor can pass through this AI model once to feedback the data V1′ in the AI based UCI report. Similarly, if a rank value of RI=2 is indicated, then two layers of a V factor (V1′ and V2′) is to be feedback using the same AI model by processing through the first V factor or V1 first and then processing through the second V factor afterwards. The outputs can be summed and all the UCI bits output can be based on a same format. Similarly, the same process can be applied for the 3 and 4 layers as associated additionally with RI=3 and 4, respectively. The layer common configuration in particular is probably less complex in comparison to the layer specific configuration 320 and rank or RI specific configuration 330, which may have advantages in terms of performance or memory savings.

Alternatively, or additionally, for reporting AI based UCI reports, the UE 110 can configure a layer specific configuration 320 based on the network configuration received from the base station 122. The layer specific configuration 320 of the AI based UCI report can be a variation of the layer common configuration except the layer specific configuration includes the same AI model being used for a transmission layer per UCI configuration. For example, the encoder-decoder pair for the layer specific configuration 320 at the RI=1 at 350 utilizes AI model 1, while the UCI configuration here may be, for example, 60 bits for the AI based UCI report. Likewise, each layer 1 (V1, V2′ as the representative input and output) of each RI 350 thru 380 also comprises the same AI model for the same UCI configuration (e.g., 60 UCI bits). If the AI based UCI feedback has two layers the first goes through the model dedicated and trained for the first factor (V1) and then for the second MIMO spatial layer another AI model is dedicated and trained for the second factor (V2). Thus, the layer specific operation include that the different encoder-decoder pairs have different statistic operations for each layer. Training a different AI model for each layer can maximize the performance for generating AI based CSI feedback in the AI based UCI reporting. Depending on the MIMO spatial layer chosen (V1, V2, V3 or V4 inputs to encoder-decoder pairs) a different AI model can execute the inferencing operations for a different AI model ID and then the output of each AI model can be processed or compressed into the UCI report following the UCI report format.

Alternatively, or additionally, for reporting AI based UCI reports, the UE 110 can configure a rank or RI specific configuration 330 based on the network configuration received from the base station 122. The RI specific configuration 330 includes a different AI model being used per RI for generating the AI based UCI report. In the RI specific configuration, rather than the input being one V factor to a neural network that takes into account different levels of a rank and outputs them together (e.g., V1′ thru V4′). Thus, if the input is an RI of 1, there is one AI model being used; for RI=2, a separate AI model is used, and the same with rank 3 or 4 even other different AI models are being used additionally. In this case, the rank or RI can be decided/selected by the UE 110, and thus, the AI model is then determined by the UE itself.

The AI models (e.g., NNs) available to the UE 110 or the base station 122 (e.g., gNB) may be trained by different entities. The UE 110 or the base station 122, for example, can receive a plurality of different models, and store them in local memory. One or more of these models may be activated for use as appropriate. For example, the network may activate, deactivate or switch the AI model at the UE 110 via signaling. Alternatively, the UE 110 may select the AI model to be used, and inform the network of its selection in the UE capability report or the AI based UCI report signaling.

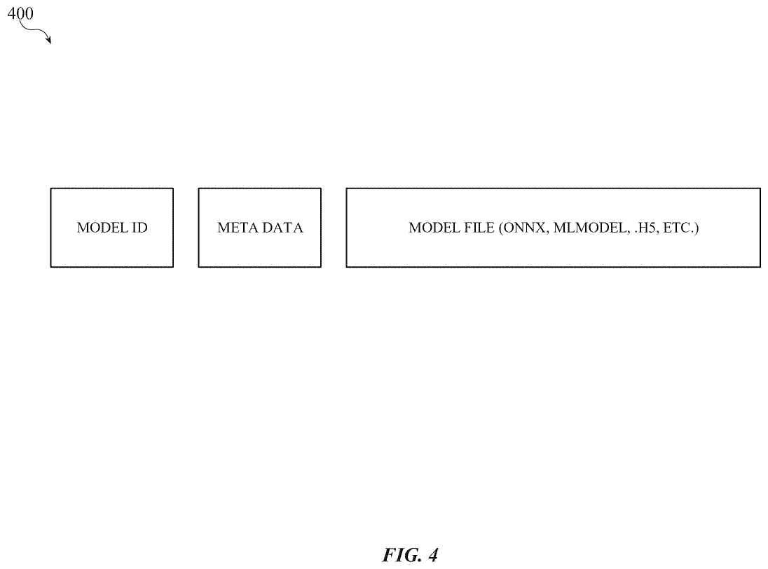

Referring to FIG. 4, illustrated is an example of AI model data 400, model description using meta data, and model ID after offline training between UE and NW. An AI model ID is reported in a network configuration, a UE capability report, or together with the AI based UCI report. In an aspect, a unique model ID or AI model ID can be assigned to each of the AI models. The model ID is used to identify the AI model unambiguously, for example, within a Public Land Mobile Network (PLMN) or among several PLMNs. The AI model ID may include an AI configuration or method that includes one or more of: a network device vendor identification, a UE vendor identification, a PLMN ID, a use case ID, number of the AI model for this use case, as well as a UCI configuration for a number of UCI bits to be utilized for reporting or feedback of CSI, a particular AI model by which to associated with the UCI configuration being indicated, and an AI method or AI configuration for reporting (e.g., a layer common configuration, a layer specific configuration, or an RI specific configuration).

The network device vendor identification can represent the network vendor which has trained the AI model, and the UE vendor identification represents the UE vendor which has trained the AI model. The PLMN ID can represent the operator network in which the AI model is applied. In addition, the use case ID can represent the use case to which the AI model is directed, if there is more than one AI model or AI configuration for a particular use case, the number of the AI model for this use case can be used to discriminate them. It is understood that, not all of the above items are necessary or are available at present. The definition of the AI model ID may be specific to the operator network for local discrimination, or may be provided in a specification for global discrimination.

The AI model may be stored and transferred as model data, which includes the model file in association with the AI model ID and metadata. The metadata is generated to describe respective AI model, and may indicate various information regarding the AI model, including but not limited to: a training status: trained and tested network, and potential training data set indication of the AI model; a functionality/object, input/output of the AI model; one or more latency benchmarks, memory requirements, accuracy of the AI model; a compression status of the AI model; an inferencing/operating condition: urban, indoor, dense macro; a pre-processing and post-processing of the measurement for AI input/output. The model file or model ID may contain or indicate model parameters for constructing the AI model or the UCI report based on a UCI payload of UCI bits outputted by the AI configuration/method, respectively. In the case of deep neural network, the model file may include layers and weights/bias of the neural network. The model is saved in a file depending on the machine learning framework that is used. For example, a first machine learning framework may save a file in a first format, while a second machine learning framework may save a file in a different format to represent ML models.

Due to diverse model formats in current AI industry, it is expected that the model trained by different vendors can have different formats. The model file may need reformatting before, during or after it is transferred to the UE or the gNB. Assuming that the AI model is stored in a first format after being trained, but the UE or the gNB may support a second format different from the first format, then a format conversion is required. As an example, the server storing the model may convert the model file format to the second format before transmitting the model. As another example, a network function (NF) in the core of the operator network may convert the model file format before forwarding the model to the gNB. As yet another example, the gNB may take the responsibility to convert the format of the model destined for the gNB or for the UE, in the latter case, the gNB then forwards the reformatted model to the UE. As yet another example, it is the UE that converts the model file format according to the UE's support capability. The AI model data may be compressed for storage and/or transfer, for example, by using standard compression methods provided in ISO-IEC 15938-17 or any other possible compression methods, which are not be described here in detail.

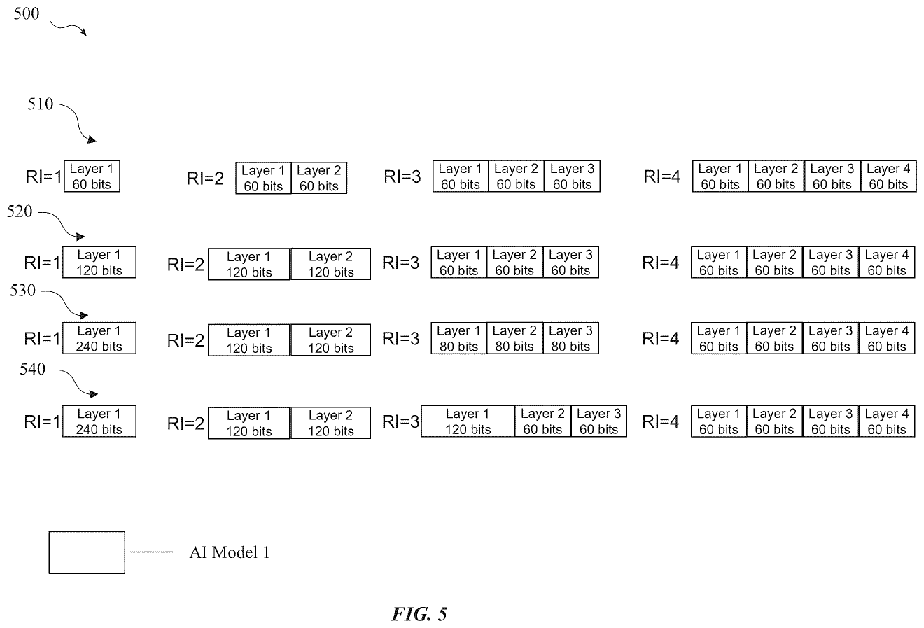

FIG. 5 illustrates an example of AI configurations or methods based on a layer common configuration 500 for generating an AI based UCI report. In the case where only one model is trained per UCI configuration (or number of UCI bits configured), although each MIMO spatial layer (or transmission layer) may configure a different payload, resulting in a different AI model. This can be categorized as a layer common configuration from AI model point of view as in this disclosure. Alternatively, this could also be considered a layer specific configuration from a UCI configuration point of view. A layer common configuration can looked at from different angles if there is only one model per UCI configuration. From the AI model point of view, it is layer common, but from a configuration point of view there can still be different AI model. For example, first MIMO layer may use 60 bits as a UCI configuration and then the second layer use 90 bits. From a configuration point of view there are still two unique network model IDs associated with the configuration of each layer.

In particular, a layer common configuration comprises a same AI model being used across a number of transmission layers of a UCI configuration, which holds for each of the AI configurations methods 510 thru 540 illustrating example layer common configurations. A layer common configuration refers to when a single/same AI model is trained for all layers per UCI configuration. A UCI configuration is one UCI bit size per layer. For example, a UCI configuration could be selected from among a set of UCI payload sizes (e.g., 60 bits, 80 bits, 90 bits, 120 bits, 240 bit, or another number of UCI bits for layer). The number of bits that a UCI configuration indicates is not limited to the illustrated examples, but can be any other number of UCI bits or set of UCI bits also. Here, a particular UCI configuration may only have a single model associated with it, so if anywhere there is a 60 bit UCI configuration, the same AI model can be utilized., Likewise, if the UCI configuration is 120 bits, wherever 120 bits are used the same AI model is as well. Then for 240 bits there is associated a same AI model, which is different from the AI model of other UCI configurations of a different number of bits. From the AI point of view this can mean that for each of the configurations there is an associated AI Model being used in the AI based UCI report.

In an aspect, a first layer common configuration 510 for AI based UCI reporting can be configured across one or more RIs with RI values of 1 through 4 in rank, for example. The base station 122 or NW can configure one AI model ID (i.e., same UCI bits for all transmission layers), which is depending on a UE rank selection. The UCI payload size can linearly increase with the increase in the RI. For example, the UE 110 can operate to generate UCI bits for the AI based UCI report based on an AI model ID of the network configuration. This AI model ID can indicate a layer common configuration for configuring a UCI payload size that linearly increases with an increase in an RI value associated with the UCI configuration. In the first AI configuration only one AI model is configured and the UE 110 can chose the RI. Depending on the selected RI, the UE 110 can process the same AI model one by one across each transmission layer, and result in a linear increase of the payload or the UCI payload based on the RI index or value. From a configuration point of view, the UE provisions the UCI bits of the UCI configuration in the UCI PUCCH feedback; therefore a large enough UCI payload would be enabled so the UE can have this flexibility to fit those bits, or an omission rule be configured for processing the limitation or omission of UCI bits satisfying or exceeding a threshold.

Alternatively, or additionally, a second layer common configuration 520 for AI based UCI reporting can be configured across one or more RIs of an RI index or value. Base station 122 or NW can configure one AI model ID for a maximum (max) RI=2, and another model ID for a max RI=4 as signaled via the network configuration, for example. Depending on UE rank selection, the UE 110 can choose a corresponding model based on rank such as the first AI Model ID or the other, second model ID. For example, if the UE 110 selects rank 1 or 2 it will choose the first AI model ID, and if RI=3 or 4, the UE 110 selects the other, second model ID using rank 3 or 4. The particular AI model ID being selected would apply to all transmission layers/MIMO spatial layers within the rank. Because there can be different AI model IDs assigned to sets of ranks such as one for max RI=2 and another for max RI=4, the UCI configuration or number of bits can double among the ranks. The UCI bits of rank 2 can be double the size of rank 1, for example. For RI=3 and 4, the same or higher number of UCI bits with respect to or when compared to RI=2 can be configured based on the network configuration. So, rank 4 and rank 2 can have a same or the exact same payload size, for example. Overall the AI configuration for the second layer common configuration 520 can minimize the maximum number of UCI bits that the UE 110 can send on the uplink in the UCI PUCCH, especially for higher RIs or ranks with more MIMO spatial layers (e.g., Layers 1 thru 4). As such, this AI configuration aspect can provide some flexibility and be consistent with the legacy design to constrain the overhead of a higher layer. As compared to the first layer common configuration 510 where the UCI payload linearly increases, the second layer common configuration can reduce the amount of overhead where rank 3 and 4 is being used.

With the second layer common configuration 520, the UE 110 can select an AI model ID indicated in the network configuration from among AI model IDs based on an RI and the UCI configuration to generate UCI bits for the AI based UCI report. The AI model ID can indicate a layer common configuration to configure a UCI payload size in the network configuration such as by one or more indications or with the AI model ID. The AI model IDs can include a first AI model ID associated with a first set of RIs and a second AI model ID associated with a second set of Ris with a greater RI value than the first set of Ris. The first AI model ID and the second model ID can indicate different AI models, respectively, that constrain the UCI payload size for the second set of Ris with respect to the first set of RIs.

Alternatively, or additionally, a third layer common configuration 530 for AI based UCI reporting can be configured across one or more RIs of an RI index or value. Base station 122 can configure one AI model per RI. Depending on the RI, the UE 110 can choose the AI model for encoding each transmission layer. The UCI per rank can be different. As such, the network can configure or the UE select one AI model for RI=1 and another for RI=2, in which the same AI model can be configured each of the layers for in RI=2, RI=3 and RI=4. As such, the third layer common configuration 530 is providing some flexibility and matching for the UCI payload size to be more constant. Here, the UE 110 is configured to select the AI model to encode each transmission layer based on an RI with a layer common configuration indicated by the network configuration. The UCI configuration is different among RIs and is associated with a number of UCI bits along with the AI model. As such, the same AI model and UCI configuration is configured per RI.

Alternatively, or additionally, a fourth layer common configuration 540 for AI based UCI reporting can be configured across one or more RIs. Base station 122 can configure one AI model per layer per RI. Depending on the RI, different UCI bits per layer is possible. Here, the UE 110 based on the network configuration can encode each transmission layer based on the AI model and based on an RI. The UCI configuration can vary or not among transmission layers of an RI.

As described above, the network or base station 122 can control the AI model to be used by the UE 110 based on one or more indications of a network configuration, including an AI model ID, a UCI configuration, an AI Model, an AI configuration/method or other indication. Alternatively, or additionally, the network or base station 122 could also configure and indicate a maximum UCI configuration size (or UCI payload size). Then the UE 110 can be enabled to choose an AI model or AI configuration/method based on the maximum UCI payload size. Thus, in the network configuration, the AI model ID can be configured to the UE, but in other alternatives, the network can configure a maximum UCI payload size so that the UE 110 can choose the AI model to process according the model ID with a selected amount of UCI bits as the UCI configuration. The UE 110 can be configured to select among the layer common configurations 510-540 based on the UCI payload size or maximum UCI payload size for generating an AI based UCI. For example, if the base station 122 configures a max UCI payload size of 240 bits for the third layer common configuration 530, the UE 110 could choose the transmission layer one as being 240 bits or 120 bits or 60 bits, or something less. Then the UE 110 can indicate the information being used such as the UCI configuration it selected to configure the AI based UCI report back to the network, either in the AI based UCI report itself or a separate signaling, for example.

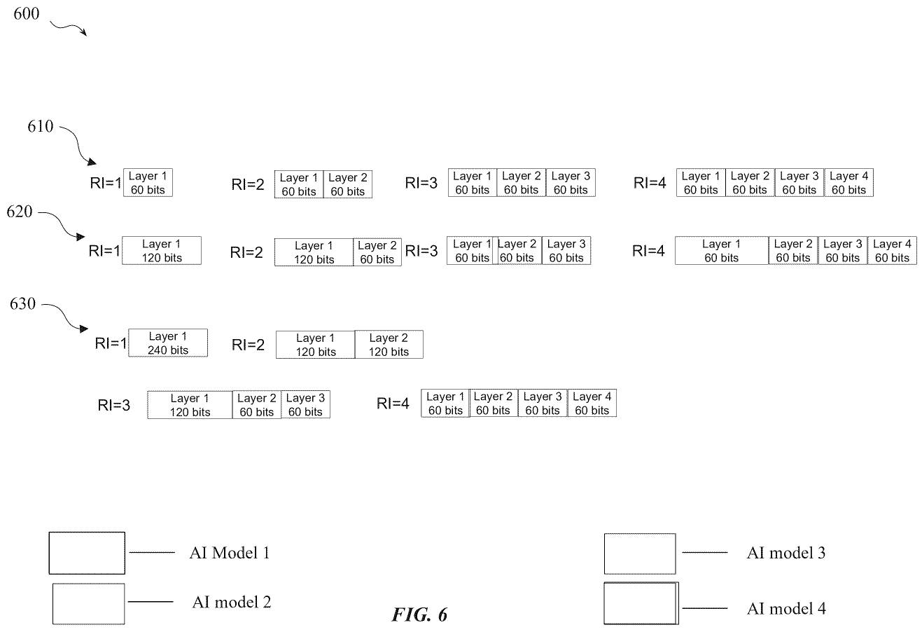

FIG. 6 illustrates an example of AI configurations or methods 600 based on one or more layer specific configurations 610 thru 630 for generating an AI based UCI report. A layer specific configuration means that regardless of the UCI configuration a different AI model is being utilized to generate output for the AI based UCI report. The complexity here can be high due to the number of AI models, storage can be four times as the layer common configuration(s), assuming a maximum of four MIMO spatial layers per UE. One AI model is trained per layer per configuration, for example.

In an aspect, a first layer specific configuration 610 for AI based UCI reporting can be configured according to one or more RIs with RI values of 1 through 4 in rank, for example. The base station 122 can transmit a network configuration to the UE 110 with one or more indications as discussed herein, such as an AI model ID, a UCI configuration of a number of UCI bits for generating the AI based UCI report, an AI model, an AI configuration or method (e.g., AI configuration 610, 620, or 630), or other indication as discussed herein. With the first layer specific configuration 610 the same UCI configuration is utilized (e.g., 60 bits) across RIs, but different AI models are used to generate the results for each transmission layer.

Through the network configuration the network or base station 122 one AI model ID per transmission layer or MIMO spatial layer (e.g., Layer 1, Layer 2, Layer 3, or Layer 4), which is the case for each layer specific configuration 610, 620 and 630. With the first layer specific configuration 610, a same UCI configuration or UCI bit number is used for each transmission layer. For example, a UCI configuration of 60, 90, or 120 bits can be configured for each of transmission layers 1/2/3/4 with respect to the RI. Even if you have the same configuration (e.g., 60 bits for all layers), the encoder-decoder pairs are still executing a different AI model under this UCI configuration with a different transmission layer as illustrated by the varied hash markings as discussed in FIG. 3 also.

The second layer specific configuration 620 can configure a different number of UC bits or UCI configuration per transmission layer. For example, UCI configurations of 60/90/120 for transmission layer 1 and 2, and other UCI configurations of 40/60/80 can be configured for layer 3 and 4. As such, a larger UCI payload can be configured for transmission layers 1 and 2 because transmission layer 2 can have a significantly higher power and lower UCI bits for transmission layers 3 and 4 and are less important compared to transmission layers 1 and 2. Then, depending on the UE rank selection or RI the UE selects, the UCI payload size can linearly increase from one RI to another in increasing value. UE 110 can then generate the AI based UCI report with the AI model based on a layer specific configuration where the AI model varies based on a transmission layer. The UCI configuration can be a same number or a different number of UCI bits among transmission layers associated with an RI, while the UCI payload size can linearly increase based on a UE rank selection of the RI.

The third layer specific configuration 630 can configure the UCI report according to an AI model ID list or data set per layer per RI. For example RI=1 can be associates with a model ID 11 for layer 1 and RI=2; model ID 12 for layer 1; model ID 22 for layer 2; RI=3: model ID 13 for layer 1, model ID 23 for layer 2, model ID 33 for layer 3. The network configuration thus can provide an AI model list or AI model ID list of everything per RI so that the UE selects from among them corresponding to each transmission layer and RI. The AI based UCI report with the AI model is based on an RI and a layer specific configuration The AI model corresponds to a transmission layer and can vary among transmission layers based on an AI Model ID list that can be different or a same for each transmission layer or RI.

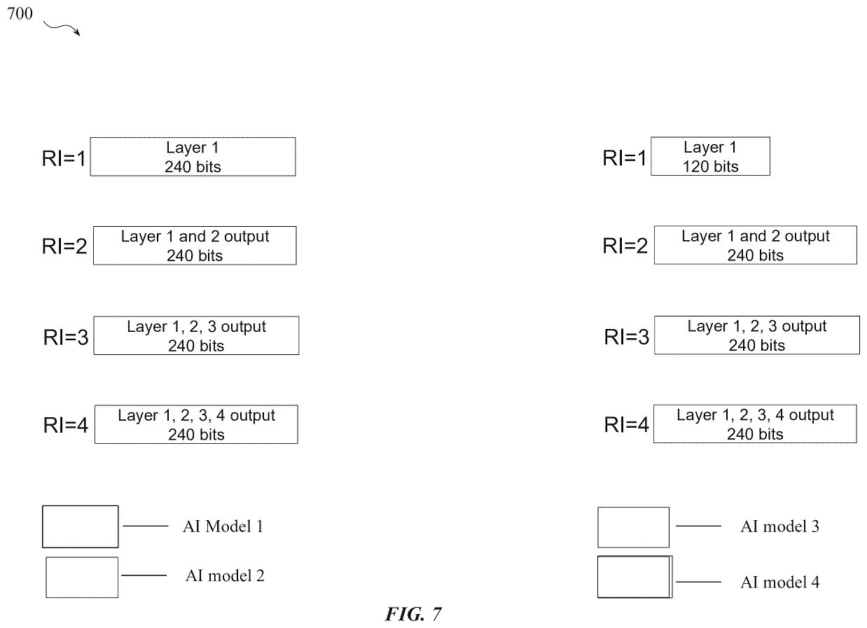

FIG. 7 illustrates an example of AI configurations or methods 700 based on one or more RI specific configurations 700 for generating an AI based UCI report. Here the network configuration can configure one AI model ID per rank or RI. The number of feedback bits per transmission layer is not separable as part of AI model optimization. The network configuration can configure a same number of output UCI bits per RI or different bits per RI. For example, on the left RI=1 is configured with a first AI model for a UCI configuration of 240 bits, while on the right RI=1 is configured with a first AI model for 120 bits for generating UCI bits in the AI based UCI report.

The AI configurations 700 are considered RI specific from a configuration point of view. So one model ID per rank is being utilized and then the feedback bits per layer are not separable. The UE outputs the AI model with a number of bits for layer one and the number of UCI bits for layer 2 is really inseparable as they are all mixed together in the output. When the decoder processes a reconstruct of them together the NW can configure the same output bits per RI, or different output bits per RI.

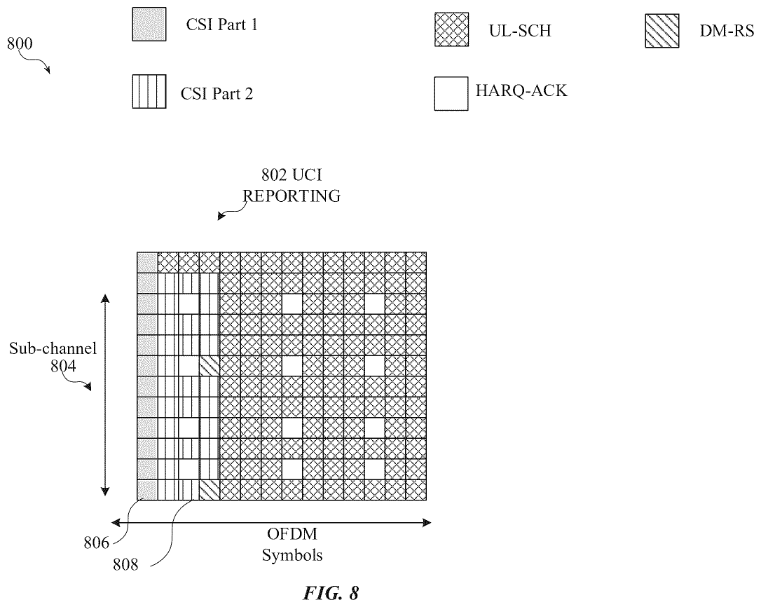

Referring to FIG. 8, illustrated is an example UCI reporting of UCI that can be based on AI based CSI modes for the UCI bits according to the various AI configurations/methods discussed herein such as the layer common configuration(s), the layer specific configuration(s), and the rank specific configuration(s). A UCI reporting 802 can be multiplexed with various sub-channels 804 for different CSI parts, including CSI part 1 806 and CSI part 2 808, in particular. CSI part 1 is needed by the base station 122 to be able to decode CSI part 2 which carries the CSI. Other symbols can include uplink scheduling (UL-SCH) information, hybrid automatic repeat request (HARQ) ACK feedback or demodulation reference signaling (DM-RS).

In an aspect, the AI based CSI compression can be configured to provide similar information. For a layer common configuration(s) and layer specific configuration(s), the UE 110 can utilize a UCI part 1 using the RI, which indirectly indicates the number of bits required for Part 2 and is based on a UCI configuration because the UCI part 2 payload size scales with RI, when the UCI configuration explicitly configures the number of bits per layer. RI, Wideband CQI and Sub-band CQI can also be configured on the UCI Part 1 or CSI part 1 as similar in the legacy design. The AI model ID can also be carried by or a part of the UCI part 1.

In an aspect, the UCI part 1 can include the AI model ID. If the AI model ID is configured by the network, once the UE is signaled an indication of the AI model ID there is no need to include the model ID in the UCI. Alternatively, or additionally, if the UE 110 determines which AI model to use, then the AI model ID can be included as a part of the UCI (e.g., in UCI part 1). Alternatively, or additionally, if the network is still in control, but now a list of AI model IDs are provided or indicated for the UE to choose from (e.g., as in the layer specific configuration 630 of FIG. 6) and one AI model ID corresponds to one AI output size per layer, then the UE chooses one and reports it back over the index of an AI model in the list. For example, if two model IDs are being configured for a UE to choose, and the UE chooses one, a one bit can be signaled to indicate the first or the second AI model ID has been selected. Alternatively, or additionally, if the AI model ID represents an AI model with an adaptive layer, and different adaptive layers can generate different output sizes, then the UE chooses one adaptive layer/output bit size and reports the selection back with the associated index of it. These aspects, can be applicable for both the layer common configuration(s) and the layer specific configurations.

For rank specific configuration(s), the UCI part 1 can include the RI as well. Because the AI model is linked to the RI, this indicates the model ID as well, when only one model ID is configured per rank. Wideband and sub-band CQI is common upon all the things. If multiple IDs are configured per rank, then the UE 110 can report the model ID index within a configured list. For example, for RI=1, model ID xx11, xx12 are configured. Then the UE additionally reports a 1 bit to indicate the model for RI=1 that is being used.

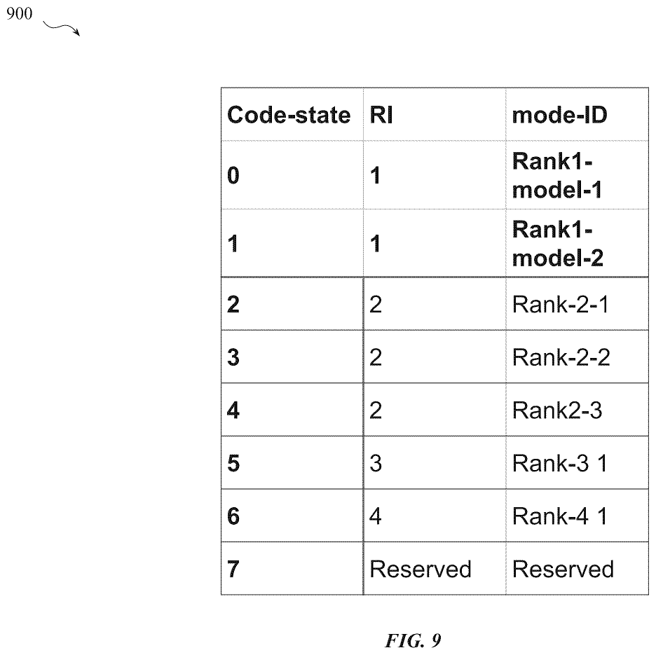

Additionally, the RI indication and model ID selection can be jointly signaled, e.g., subject to network configuration through RRC or MAC CE. In one example, with 3 bits signaling overhead a table can be configured as illustrated in FIG. 9 through a radio resource control (RRC)/medium access control (MAC) control element (MAC CE).

In an aspect, UCI part 1 can be a fixed size with known corresponding bits, in which information corresponds to which bits, but UCI part 2 can be flexible in size and depending on the RI, UCI part 2 can be larger or smaller in size. The UCI part 2 size can derive form UCI part 1. With all the information from UCI part 1, the base station can know exactly how large the UCI part 2 is and what information and the AI configuration/method.

For a layer common configuration/method, the UCI part 2 can include a CSI generation model output for each transmission layer. Depending on the RI, starting from layer 1, followed by layer 2, etc., each can be executed one by one. Then depending on the RI, the format can start from layer 1, followed by layer 2, and so on to layer 3 and layer 4 for the format of UCI part 2. For a layer specific configuration, the format can be similar to the layer common configuration/ method, depending on UCI part 1, layer 1 can be first, layer 2 second, then layer 3, and then the AI model operating at each one is different, but the format is the same. UCI part 2 includes CSI generation model output for each transmission layer. Depending on RI, the output of transmission layer 1 uses its corresponding model, the output of layer 2 uses its corresponding AI models, and likewise for layer 3 and 4 across the UCI part 2.

For rank specific, the transmission layers 1, 2, 3 and 4 can all be mixed together so that it may be difficult to know which is which across the UCI part 2. CSI generation model output can put all the outputs into UCI part 2 based on the AI model output itself by a one by one bit or in a bit by bit order.

In an aspect, the UE 110 can further operate with a limited omission rule based on the layer common configuration(s) and layer specific configuration(s). The CSI generation model output for layer 1>layer 2>layer 3. A UCI bit omission for the CSI Part 2 can then be based on a priority order associated with a layer common configuration or the layer specific configuration, wherein the priority order decreases from a higher layer to a lower layer. If the UCI bits are limited, such as by the network configuration providing a maximum UCI payload size, then the UE 110 may have to drop or omit some UCI bits to fit into the AI based UCI report. In this case, transmission layer 3 or 4 bits could be dropped first, followed by transmission layer 2 and followed by transmission layer 1. For rank specific configuration(s), no omission rule is configured because all the information is mixed together. As such, dropping any part will mean the transmission layer decoding would not be accurate. As such, AI based UCI reporting of rank specific configurations for UCI bits outputted has no omission process. Instead, the UE 110 can choose the rank to fit into the payload size.

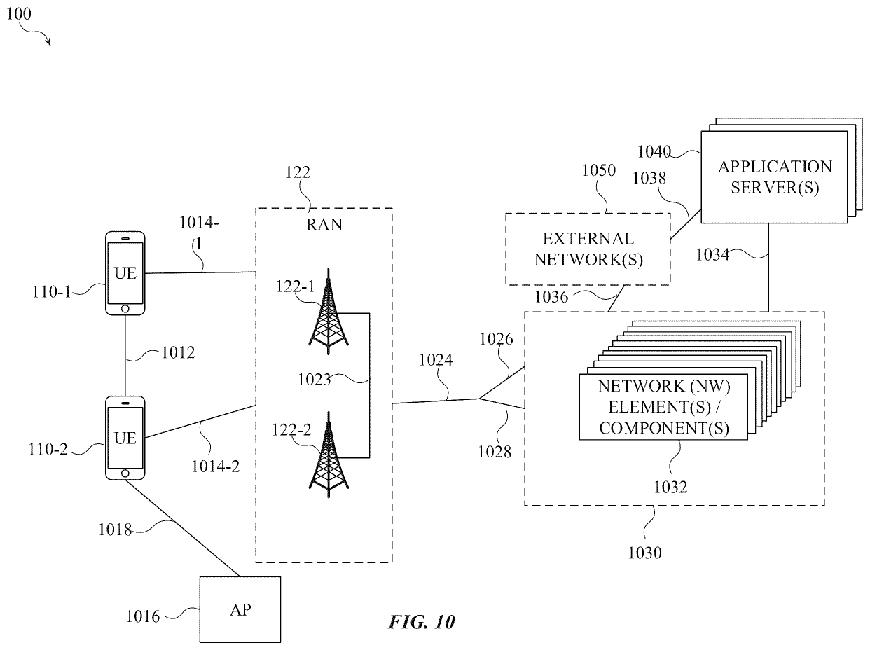

FIG. 10 is an example network 1000 according to one or more implementations described herein. Example network 100 can include UEs 110-1, 110-2, etc. (referred to collectively as “UEs 110” and individually as “UE 110”), a radio access network (RAN) 1020, a core network (CN) 1030, application servers 1040, and external networks 1050.

UEs 110 can communicate and establish a connection with (be communicatively coupled to) RAN 1020, which can involve one or more wireless channels 1014-1 and 1014-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes or base stations 122 (e.g., 122-1 and 122-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 1030. Additionally, at least one of the MN or the SN can be operated with shared spectrum channel access, and functions specified for UE 110 can be used for an integrated access and backhaul mobile termination (IAB-MT). Similar for UE 110, the IAB-MT can access the network using either one network node or using two different nodes with enhanced dual connectivity (EN-DC) architectures, new radio dual connectivity (NR-DC) architectures, or other direct connectivity such as an SL communication channel as an SL interface 112.

In some implementations, a base station (as described herein) can be an example of network node 122. As shown, UE 110 can additionally, or alternatively, connect to access point (AP) 1016 via connection interface 1018, which can include an air interface enabling UE 110 to communicatively couple with AP 1016. AP 1016 can comprise a wireless local area network (WLAN), WLAN node, WLAN termination point, etc. The connection 1018 can comprise a local wireless connection, such as a connection consistent with any IEEE 702.11 protocol, and AP 1016 can comprise a wireless fidelity (Wi-Fi®) router or other AP. AP 1016 could be also connected to another network (e.g., the Internet) without connecting to RAN 1020 or CN 1030.

RAN 1020 can also include one or more RAN nodes 122-1 and 122-2 (referred to collectively as RAN nodes 122, and individually as RAN node 122) that enable channels 1014-1 and 1014-2 to be established between UEs 110 and RAN 1020. RAN nodes 122 can include network access points configured to provide radio baseband functions for data or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 can include a roadside unit (RSU), a transmission reception point (TRxP or TRP), and one or more other types of ground stations (e.g., terrestrial access points). In some scenarios, RAN node 122 can be a dedicated physical device, such as a macrocell base station, or a low power (LP) base station for providing femtocells, picocells or other like having smaller coverage areas, smaller user capacity, or higher bandwidth compared to macrocells. As described below, in some implementations, satellites 160 can operate as bases stations (e.g., RAN nodes 122) with respect to UEs 110. As such, references herein to a base station, RAN node 122, etc., can involve implementations where the base station, RAN node 122, etc., is a terrestrial network node and also to implementation where the base station, RAN node 122, etc., is a non-terrestrial network node.

Some or all of RAN nodes 122 can be implemented as one or more software entities running on server computers as part of a virtual network, which can be referred to as a centralized RAN (CRAN) or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 122; a media access control (MAC)/physical (PHY) layer split wherein RRC, PDCP, radio link control (RLC), and MAC layers can be operated by the CRAN/vBBUP and the PHY layer can be operated by individual RAN nodes 122; or a “lower PHY” split wherein RRC, PDCP, RLC, MAC layers and upper portions of the PHY layer can be operated by the CRAN/vBBUP and lower portions of the PHY layer can be operated by individual RAN nodes 122. This virtualized framework can allow freed-up processor cores of RAN nodes 122 to perform or execute other virtualized applications, for example.

In some implementations, an individual RAN node 122 can represent individual gNB-distributed units (DUs) connected to a gNB-control unit (CU) via individual F1 interfaces. In such implementations, the gNB-DUs can include one or more remote radio heads or radio frequency (RF) front end modules (RFEMs), and the gNB-CU can be operated by a server (not shown) located in RAN 1020 or by a server pool (e.g., a group of servers configured to share resources) in a similar manner as the CRAN/vBBUP. Additionally, or alternatively, one or more of RAN nodes 122 can be next generation eNBs (i.e., gNBs) that can provide evolved universal terrestrial radio access (E-UTRA) user plane and control plane protocol terminations toward UEs 110, and that can be connected to a 5G core network (5GC) 1030 via a Next Generation (NG) interface 1024.

Any of the RAN nodes 122 can terminate an air interface protocol and can be the first point of contact for UEs 110. In some implementations, any of the RAN nodes 122 can fulfill various logical functions for the RAN 1020 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations cannot be limited in this regard. The OFDM signals can comprise a plurality of orthogonal subcarriers.

A physical downlink shared channel (PDSCH) can carry user data and higher layer signaling to UEs 110. The physical downlink control channel (PDCCH) can carry information about the transport format and resource allocations related to the PDSCH channel, among other things. The PDCCH can also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) can be performed at any of the RAN nodes 122 based on channel quality information fed back from any of UEs 110. The downlink resource assignment information can be sent on the PDCCH used for (e.g., assigned to) each of UEs 110.

The PDCCH uses control channel elements (CCEs) to convey the control information, wherein a number of CCEs (e.g., 6 or other number) can consists of a resource element groups (REGs), where a REG is defined as a physical resource block (PRB) in an OFDM symbol. Before being mapped to resource elements, the PDCCH complex-valued symbols can first be organized into quadruplets, which can then be permuted using a sub-block interleaver for rate matching, for example. Each PDCCH can be transmitted using one or more of these CCEs, where each CCE can correspond to nine sets of four physical resource elements known as REGs. Four quadrature phase shift keying (QPSK) symbols can be mapped to each REG. The PDCCH can be transmitted using one or more CCEs, depending on the size of the DCI and the channel condition. There can be four or more different PDCCH formats with different numbers of CCEs (e.g., aggregation level, L=1, 2, 4, 8, or 16).

The RAN nodes 122 may be configured to communicate with one another via interface 1023. In implementations where the system is an LTE system, interface 1023 may be an X2 interface. In LTE networks, X2 and S1 interface are defined as the interfaces between RAN nodes and between RAN and Core Network. 5G may operate in two modes as non-standalone and standalone mode. For non-standalone operation the specification defines the extension for S1 and X2 interfaces as for standalone operation as X2/Xn for the interface between RAN nodes 122 and S1/NG for the interface 1024 between RAN 120 and CN 1030. The interface 1024 may be defined between two or more RAN nodes 122 (e.g., two or more eNBs/gNBs or a combination thereof) that connect to evolved packet core (EPC), the CN 1030, or between eNBs connecting to an EPC. In some implementations, the X2/Xn interface may include an X2/Xn user plane interface (X2-U/Xn-U) and an X2 control plane interface (X2-C/Xn-C). The X2-U/Xn-U may provide flow control mechanisms for user data packets transferred over the X2/Xn interface and may be used to communicate information about the delivery of user data between eNBs or gNBs. For example, the X2-U/Xn-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C/Xn-C may provide intra-LTE access mobility functionality (e.g., including context transfers from source to target eNBs, user plane transport control, etc.), load management functionality, and inter-cell interference coordination functionality.

Alternatively, or additionally, RAN 1020 can be also connected (e.g., communicatively coupled) to CN 1030 via a Next Generation (NG) interface as interface 1024. The NG interface 1024 can be split into two parts, a Next Generation (NG) user plane (NG-U) interface 1026, which carries traffic data between the RAN nodes 122 and a User Plane Function (UPF), and the S1 control plane (NG-C) interface 1028, which is a signaling interface between the RAN nodes 122 and Access and Mobility Management Functions (AMFs).

CN 1030 can comprise a plurality of network elements 1032, which are configured to offer various data and telecommunications services to customers/subscribers (e.g., users of UEs 110) who are connected to the CN 1030 via the RAN 1020. In some implementations, CN 1030 can include an evolved packet core (EPC), a 5G CN, and/or one or more additional or alternative types of CNs. The components of the CN 1030 can be implemented in one physical node or separate physical nodes including components to read and execute instructions from a machine-readable or computer-readable medium (e.g., a non-transitory machine-readable storage medium).

As shown, CN 1030, application servers 1040, and external networks 1050 can be connected to one another via interfaces 1034, 1036, and 1038, which can include IP network interfaces. Application servers 1040 can include one or more server devices or network elements (e.g., virtual network functions (VNFs) offering applications that use IP bearer resources with CN 1030 (e.g., universal mobile telecommunications system packet services (UMTS PS) domain, LTE PS data services, etc.). Application servers 1040 can also, or alternatively, be configured to support one or more communication services (e.g., voice over IP (VoIP sessions, push-to-talk (PTT) sessions, group communication sessions, social networking services, etc.) for UEs 110 via the CN 1030. Similarly, external networks 1050 can include one or more of a variety of networks, including the Internet, thereby providing the mobile communication network and UEs 110 of the network access to a variety of additional services, information, interconnectivity, and other network features.

In an aspect, the UE 110 can operate via the processing circuitry by receiving a network configuration associated with an AI based UCI report. The network configuration can include one or more indications of a UCI configuration and an AI model to generate the AI based UCI report. The UE transmits the AI based UCI report based on the network configuration. The UE 110 can generate the AI based UCI report with the AI model. The AI model can be associated with at least one of: a layer common configuration, a layer specific configuration, or a rank indication (RI) specific configuration, based on the indications of the AI model and the UCI configuration. The AI model can comprises a two-sided model that performs an AI based CSI compression for the AI based UCI report. The layer common configuration includes a same AI model being used across a number of transmission layers of the UCI configuration. The layer specific configuration includes the same AI model being used for a transmission layer per UCI configuration. The RI specific configuration includes a different AI model being used per RI. The network configuration can include an AI model ID that indicates at least one of: the UCI configuration that is associated with a number of UCI bits, the AI model that includes an AI model index and the UCI configuration, an AI configuration or AI method, a UE vendor identification, a network device vendor identification, a use case ID of a use case, or a model number for the use case ID.

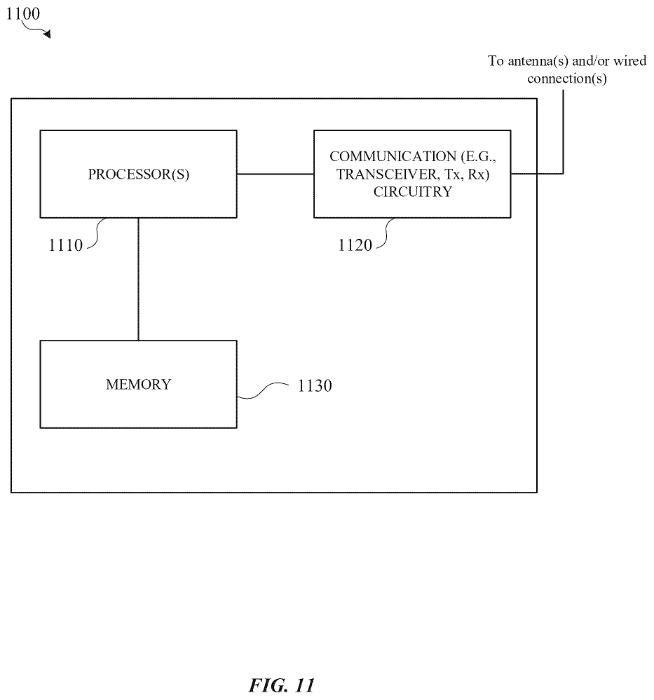

Referring to FIG. 11, illustrated is a block diagram of a UE device 110 (e.g., UE 110-1 or 110-2) or other network device/component (e.g., V-UE/P-UE, IoT, gNB, eNB, base station 122 or other participating network entity/component) 1100. The device 1100 includes one or more processors 1110 (e.g., one or more baseband processors) comprising processing circuitry and associated interface(s), transceiver circuitry 1120 (e.g., comprising RF circuitry, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 1130 (which can comprise any of a variety of storage mediums and can store instructions and/or data associated with one or more of processor(s) 1110 or transceiver circuitry 1120).

Memory 1130 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Any connection can be also termed a computer-readable medium.

Memory 1130 can include executable instructions, and be integrated in, or communicatively coupled to, processor or processing circuitry 1110. The executable instructions of the memory 1130 can cause processing circuitry 1110 to receive/process the instructions to initiate a U2U relay path through a first relay UE to a destination UE by providing a direct communication request to the first relay UE. A U2U relay reselection can be performed to a second relay UE in response to a trigger condition. The trigger condition can be based on at least one of: a measurement of a first or second channel link to the first relay UE being below a (pre)configured threshold, a detection of a radio link failure (RLF) on the first or second channel link, a notification based on a channel link between the first relay UE and the destination UE, or the source UE and the first relay UE, or a reception of a release message. Then the U2U relay can further be established to the destination UE through the second relay UE, as well as other aspects described in this disclosure.

Memory 1130 can include executable instructions, and be integrated in, or communicatively coupled to, processor or processing circuitry 1110. The executable instructions of the memory 1130 can cause processing circuitry 1110 to

[symbol]

The device 1100 is configured to process, perform, generate, communicate or cause execution of any one or more combined aspects described herein or in association with any of the FIG. 1 thru 10.

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure is described with reference to attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can be also a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

A first example is an apparatus in a user equipment (UE), the apparatus comprising: a memory; processing circuitry, coupled to the memory, configured to, when executing instructions stored in the memory, cause the UE to: receive a network configuration associated with an artificial intelligence (AI) based uplink control information (UCI) report, wherein the network configuration comprises one or more indications of a UCI configuration and an AI model to generate the AI based UCI report; and transmit the AI based UCI report based on the network configuration.

A second example can include the first example, wherein the instructions, when executed by the processing circuitry, further configure the apparatus to: generate the AI based UCI report with the AI model, wherein the AI model is associated with at least one of: a layer common configuration, a layer specific configuration, or a rank indication (RI) specific configuration, based on the indications of the AI model and the UCI configuration, wherein the AI model comprises a two-sided model that performs an AI based CSI compression for the AI based UCI report.

A third example can include the first or second example, wherein the layer common configuration includes a same AI model being used across a number of transmission layers of the UCI configuration, wherein the layer specific configuration includes the same AI model being used for a transmission layer per UCI configuration, and wherein the RI specific configuration includes a different AI model being used per RI.

A fourth example can include any one or more of the first through third examples, wherein the network configuration further indicates an AI model ID that indicates at least one of: the UCI configuration that is associated with a number of UCI bits, the AI model that includes an AI model index and the UCI configuration, an AI configuration or AI method, a UE vendor identification, a network device vendor identification, a use case ID of a use case, or a model number for the use case ID.

A fifth example can include any one or more of the first through fourth examples, wherein the instructions, when executed by the processing circuitry, further configure the processing circuitry to: generate UCI bits for the AI based UCI report based on an AI model ID of the network configuration, wherein the AI model ID indicates a layer common configuration for configuring a UCI payload size that linearly increases with an increase in an RI value associated with the UCI configuration.

A sixth example can include any one or more of the first through fifth examples, wherein the instructions, when executed by the processing circuitry, further configure the processing circuitry to: select an AI model ID indicated in the network configuration from among a plurality of AI model IDs based on an RI and the UCI configuration to generate UCI bits for the AI based UCI report; and wherein the AI model ID indicates a layer common configuration to configure a UCI payload size, wherein the plurality of AI model IDs comprise a first AI model ID associated with a first set of RIs and a second AI model ID associated with a second set of RIs with a greater RI value than the first set of RIs, and wherein the first AI model ID and the second model ID comprise different AI models, respectively, that constrain the UCI payload size for the second set of RIs with respect to the first set of RIs.

A seventh example can include any one or more of the first through sixth examples, wherein the instructions, when executed by the processing circuitry, further configure the processing circuitry to: select the AI model to encode each transmission layer based on an RI with a layer common configuration indicated by the network configuration, wherein the UCI configuration is different among RIs and is associated with a number of UCI bits.

An eighth example can include any one or more of the first through seventh examples, wherein the instructions, when executed by the processing circuitry, further configure the processing circuitry to: encode each transmission layer based on the AI model and an RI with a layer common configuration indicated by the network configuration, wherein the UCI configuration varies among transmission layers or does not vary based on the RI.

A ninth example can include any one or more of the first through eighth examples, wherein the instructions, when executed by the processing circuitry, further configure the processing circuitry to: select the AI model based on a maximum UCI payload size indicated by the network configuration.

A tenth example can include any one or more of the first through ninth examples, wherein the instructions, when executed by the processing circuitry, further configure the processing circuitry to: provide a UE capability report that indicates support for at least one of: one or more AI models, one or more AI model IDs associated with the one or more AI models, or one or more UCI configurations for the AI based UCI report.

An eleventh example can include any one or more of the first through tenth examples, wherein the instructions, when executed by the processing circuitry, further configure the processing circuitry to: generate the AI based UCI report with the AI model based on a layer specific configuration where the AI model varies based on a transmission layer, wherein the UCI configuration is a same number or a different number of UCI bits among transmission layers associated with an RI, and a UCI payload size linearly increases based on a UE rank selection of the RI.

A twelfth example can include any one or more of the first through eleventh examples, wherein the instructions, when executed by the processing circuitry, further configure the processing circuitry to: generate the AI based UCI report with the AI model that is based on an RI and a layer specific configuration in which the AI model corresponds to a transmission layer and varies among transmission layers, and based on an AI Model ID list that is different for each transmission layer and RI.

A thirteenth example can include any one or more of the first through twelfth examples, wherein the instructions, when executed by the processing circuitry, further configure the processing circuitry to: generate the AI based UCI report with the AI model based on an RI specific configuration that includes a different AI model associated with different RIs, respectively, based on the network configuration, wherein the network configuration indicates a same or a different number of output bits per RI.

A fourteenth example can include any one or more of the first through thirteenth examples, wherein the instructions, when executed by the processing circuitry, further configure the processing circuitry to: generate the AI based UCI report based on the network configuration, wherein a channel state information (CSI) Part 1 of the AI based UCI report indicates the size of CSI part 2 through an AI model ID based on whether the network configuration alone, or the UE determines which AI model to utilize for generating UCI bits with a layer common configuration or a layer specific configuration; or generate the AI based UCI report based on the network configuration, wherein the CSI part 1 of the AI based UCI report indicates an AI model ID based on a number of AI model IDs for a UE selection, wherein the AI Model ID is associated with the UE selection for generating UCI bits with a layer common configuration or a layer specific configuration; or generate the AI based UCI report based on the network configuration, wherein the CSI part 1 of the AI based UCI report indicates the output bit size of an AI model with an adaptation layer based on a number of adaptation layers for the UE selection, wherein the AI model ID and corresponding adaption layer is associated with the UE selection for generating UCI bits for the layer common configuration or the layer specific configuration A fifteenth example can include any one or more of the first through sixteenth examples, wherein the instructions, when executed by the processing circuitry, further configure the processing circuitry to: generate the AI based UCI report based on the network configuration for a rank specific configuration, wherein a UCI Part 1 of the AI based UCI report provides an RI that indicates a AI model ID associated with the RI, and in response to more than one AI model ID being associated with the RI, the UCI Part 1 further includes an AI model ID index, or the RI and the AI model ID are signaled via the network configuration by a radio resource control (RRC) signaling or a medium access control (MAC) control element (MAC CE) signaling.

A sixteenth example can include any one or more of the first through seventeenth examples, wherein the instructions, when executed by the processing circuitry, further configure the processing circuitry to: generate the AI based UCI report with a CSI Part 2, wherein the CSI Part 2 includes: a CSI generation model output for each transmission layer depending on a selected RI in a sequential order of transmission layers with a layer common configuration, the CSI generation model output for each transmission layer depending on the selected RI and a corresponding AI model output for a layer specific configuration, or generate the CSI generation model output for a rank specific configuration.

A seventeenth example can include any one or more of the first through sixteenth examples, wherein the instructions, when executed by the processing circuitry, further configure the processing circuitry to: generate a UCI bit omission for the CSI Part 2 based on a priority order associated with a layer common configuration or the layer specific configuration, wherein the priority order decreases from a higher layer to a lower layer.

An eighteenth example can be a method of a user equipment (UE) comprising: receiving, via processing circuitry, a network configuration associated with an uplink control information (UCI) payload of an artificial intelligence (AI) based channel state information (CSI) feedback, wherein the network configuration comprises one or more indications of a UCI configuration and an AI model to generate an AI based UCI report; and transmitting the AI based UCI report based on the network configuration.

A nineteenth example can include the eighteenth examples, further comprising: generating the AI based UCI report with the AI model, wherein the AI model is associated with at least one of: a layer common configuration, a layer specific configuration, or a rank indication (RI) specific configuration, based on the one or more indications of the UCI configuration and the AI model, wherein the AI model comprises a two-sided model that performs an AI based CSI compression for the AI based UCI report, wherein the layer common configuration includes a same AI model being used across a number of transmission layers of the UCI configuration, wherein the layer specific configuration includes the same AI model being used for a transmission layer per UCI configuration, and wherein the RI specific configuration includes a different AI model being used per RI.

A twentieth example can be a base station, the apparatus comprising: a memory; processing circuitry, coupled to the memory, configured to, when executing instructions stored in the memory, cause the base station to: transmit a network configuration for an artificial intelligence (AI) based UCI report, wherein the network configuration comprises indications of a UCI configuration and an AI model; and receive the AI based UCI report based on the network configuration.

A twenty-first example can include the twentieth example, wherein the network configuration indicates an AI model ID with a layer common configuration for configuring UCI bits of a UCI payload size in the AI based UCI report, and wherein the UCI payload size linearly increases with an increase in an RI that is associated with the UCI configuration comprising a number of UCI bits for each transmission layer, or wherein the UCI configuration is different among RIs with one AI model associated with each RI, according to indications of the network configuration.

A twenty-second example can include any one or more of the twentieth through twenty-first examples, wherein the network configuration indicates an AI model ID associated with a layer common configuration for configuring UCI bits of a UCI payload size in the AI based UCI report, and wherein the network configuration further indicates a maximum RI associated with the AI model ID and another maximum RI associated with another AI model ID for a different AI model and a same or a higher number of UCI bits than the AI model ID or wherein the UCI configuration varies among transmission layers of an RI.

A twenty-third example can include any one or more of the twentieth through twenty-second examples, wherein the network configuration indicates a layer specific configuration so that the AI model is varied based on a transmission layer of an RI, and further indicates that the UCI configuration is a same number or a different number of UCI bits among transmission layers associated with the RI, so that a UCI payload size linearly increases with an increase in an RI value of the RI.

A twenty-fourth example can include any one or more of the twentieth through twenty-third examples, wherein the network configuration indicates a layer specific configuration to be utilized for the AI based UCI report, wherein the AI model varies among different transmission layers with an AI model list that is different for each transmission layer and RI, or wherein the network configuration indicates an RI specific configuration that includes a different AI model associated with different RIs, respectively, and indicates a same or a different number of output bits per RI.

A twenty-fifth example can include any one or more of the twentieth through twenty-fourth examples, wherein the network configuration indicates a maximum UCI payload size to enable a UE to select the AI model and the UC configuration based on at least one of: a layer common configuration, a layer specific configuration, or a rank indication (RI) specific configuration, based on the indications of the AI model and the UCI configuration, wherein the AI model comprises a two-sided model that performs an AI based CSI compression for the AI based UCI report.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1. A user equipment (UE), comprising:
a memory;
processing circuitry, coupled to the memory, configured to, when executing instructions stored in the memory, cause the UE to:
receive a network configuration associated with an artificial intelligence (AI) based uplink control information (UCI) report, wherein the network configuration comprises one or more indications of a UCI configuration and an AI model to generate the AI based UCI report; and
transmit the AI based UCI report based on the network configuration.

2. The UE of claim 1, wherein the instructions, when executed by the processing circuitry, further cause the UE to:
generate the AI based UCI report with the AI model, wherein the AI model is associated with at least one of: a layer common configuration, a layer specific configuration, or a rank indication (RI) specific configuration, based on the indications of the AI model and the UCI configuration, wherein the AI model comprises a two-sided model that performs an AI based CSI compression for the AI based UCI report, wherein the layer common configuration includes a same AI model being used across a number of transmission layers of the UCI configuration, wherein the layer specific configuration includes the same AI model being used for a transmission layer per UCI configuration, and wherein the RI specific configuration includes a different AI model being used per RI.

3. The UE of claim 1, wherein the network configuration further indicates an AI model ID that indicates at least one of: the UCI configuration that is associated with a number of UCI bits, the AI model that includes an AI model index and the UCI configuration, an AI configuration or AI method, a UE vendor identification, a network device vendor identification, a use case ID of a use case, or a model number for the use case ID.

4. The UE of claim 1, wherein the instructions, when executed by the processing circuitry, further cause the UE to:
generate UCI bits for the AI based UCI report based on an AI model ID of the network configuration, wherein the AI model ID indicates a layer common configuration for configuring a UCI payload size that linearly increases with an increase in an RI value associated with the UCI configuration.

5. The UE of claim 1, wherein the instructions, when executed by the processing circuitry, further cause the UE:
select an AI model ID indicated in the network configuration from among a plurality of AI model IDs based on an RI and the UCI configuration to generate UCI bits for the AI based UCI report; and
wherein the AI model ID indicates a layer common configuration to configure a UCI payload size, wherein the plurality of AI model IDs comprise a first AI model ID associated with a first set of RIs and a second AI model ID associated with a second set of RIs with a greater RI value than the first set of RIs, and wherein the first AI model ID and the second model ID comprise different AI models, respectively, that constrain the UCI payload size for the second set of Ris with respect to the first set of RIs.

6. The UE of claim 1, wherein the instructions, when executed by the processing circuitry, further cause the UE to:
select the AI model to encode each transmission layer based on an RI with a layer common configuration indicated by the network configuration, wherein the UCI configuration is different among RIs and is associated with a number of UCI bits.

7. The UE of claim 1, wherein the instructions, when executed by the processing circuitry, further cause the UE to:
encode each transmission layer based on the AI model and an RI with a layer common configuration indicated by the network configuration, wherein the UCI configuration varies among transmission layers or does not vary based on the RI.

8. The UE of claim 1, wherein the instructions, when executed by the processing circuitry, further cause the UE to:
select the AI model based on a maximum UCI payload size indicated by the network configuration.

9. The UE of claim 1, wherein the instructions, when executed by the processing circuitry, further cause the UE to:
provide a UE capability report that indicates support for at least one of: one or more AI models, one or more AI model IDs associated with the one or more AI models, or one or more UCI configurations for the AI based UCI report.

10. The UE of claim 1, wherein the instructions, when executed by the processing circuitry, further cause the UE to:
generate the AI based UCI report with the AI model based on a layer specific configuration where the AI model varies based on a transmission layer, wherein the UCI configuration is a same number or a different number of UCI bits among transmission layers associated with an RI, and a UCI payload size linearly increases based on a UE rank selection of the RI.

11. The UE of claim 1, wherein the instructions, when executed by the processing circuitry, further cause the UE to:
generate the AI based UCI report with the AI model that is based on an RI and a layer specific configuration in which the AI model corresponds to a transmission layer and varies among transmission layers, and based on an AI Model ID list that is different for each transmission layer and RI.

12. The UE of claim 1, wherein the instructions, when executed by the processing circuitry, further cause the UE to:
generate the AI based UCI report with the AI model based on an RI specific configuration that includes a different AI model associated with different RIs, respectively, based on the network configuration, wherein the network configuration indicates a same or a different number of output bits per RI.

13. The UE of claim 1, wherein the instructions, when executed by the processing circuitry, further cause the UE to:
generate the AI based UCI report based on the network configuration, wherein a channel state information (CSI) Part 1 of the AI based UCI report indicates a size of CSI part 2 through an AI model ID based on whether the network configuration alone, or the UE determines which AI model to utilize for generating UCI bits with a layer common configuration or a layer specific configuration; or
generate the AI based UCI report based on the network configuration, wherein the CSI part 1 of the AI based UCI report indicates an AI model ID based on a number of AI model IDs for a UE selection, wherein the AI Model ID is associated with the UE selection for generating UCI bits with a layer common configuration or a layer specific configuration; or
generate the AI based UCI report based on the network configuration, wherein the CSI part 1 of the AI based UCI report indicates an output bit size of an AI model with an adaptation layer based on a number of adaptation layers for the UE selection, wherein the AI model ID and corresponding adaption layer is associated with the UE selection for generating UCI bits for the layer common configuration or the layer specific configuration.

14. The UE of claim 1, wherein the instructions, when executed by the processing circuitry, further cause the UE to:
generate the AI based UCI report based on the network configuration for a rank specific configuration, wherein a UCI Part 1 of the AI based UCI report provides an RI that indicates a AI model ID associated with the RI, and in response to more than one AI model ID being associated with the RI, the UCI Part 1 further includes an AI model ID index, or the RI and the AI model ID are signaled via the network configuration by a radio resource control (RRC) signaling or a medium access control (MAC) control element (MAC CE) signaling.

15. The UE of claim 1, wherein the instructions, when executed by the processing circuitry, further cause the UE to:
generate the AI based UCI report with a CSI Part 2, wherein the CSI Part 2 includes: a CSI generation model output for each transmission layer depending on a selected RI in a sequential order of transmission layers with a layer common configuration, the CSI generation model output for each transmission layer depending on the selected RI and a corresponding AI model output for a layer specific configuration;
generate the CSI generation model output for a rank specific configuration; or
generate a UCI bit omission for the CSI Part 2 based on a priority order associated with a layer common configuration or the layer specific configuration, wherein the priority order decreases from a higher layer to a lower layer.

16. A baseband processor configured to perform operations comprising:
receiving, via processing circuitry, a network configuration associated with an uplink control information (UCI) payload of an artificial intelligence (AI) based channel state information (CSI) feedback, wherein the network configuration comprises one or more indications of a UCI configuration and an AI model to generate an AI based UCI report; and
sending the AI based UCI report based on the network configuration.

17. The baseband processor of claim 16, further comprising:
generating the AI based UCI report with the AI model, wherein the AI model is associated with at least one of: a layer common configuration, a layer specific configuration, or a rank indication (RI) specific configuration, based on the one or more indications of the UCI configuration and the AI model, wherein the AI model comprises a two-sided model that performs an AI based CSI compression for the AI based UCI report, wherein the layer common configuration includes a same AI model being used across a number of transmission layers of the UCI configuration, wherein the layer specific configuration includes the same AI model being used for a transmission layer per UCI configuration, and wherein the RI specific configuration includes a different AI model being used per RI.

18. A base station, comprising:
a memory;
processing circuitry, coupled to the memory, configured to, when executing instructions stored in the memory, cause the base station to:
transmit a network configuration for an artificial intelligence (AI) based UCI report, wherein the network configuration comprises indications of a UCI configuration and an AI model; and
receive the AI based UCI report based on the network configuration.

19. The base station of claim 18, wherein the network configuration indicates an AI model ID with a layer common configuration for configuring UCI bits of a UCI payload size in the AI based UCI report, and wherein the UCI payload size linearly increases with an increase in an RI that is associated with the UCI configuration comprising a number of UCI bits for each transmission layer, or wherein the UCI configuration is different among RIs with one AI model associated with each RI, according to indications of the network configuration.

20. The base station of claim 18, wherein the network configuration indicates an AI model ID associated with a layer common configuration for configuring UCI bits of a UCI payload size in the AI based UCI report, and wherein the network configuration further indicates a maximum RI associated with the AI model ID and another maximum RI associated with another AI model ID for a different AI model and a same or a higher number of UCI bits than the AI model ID or wherein the UCI configuration varies among transmission layers of an RI.
